(19) United States
(12) Patent Application Publication
(10) Pub. No.: US 2002/0078901 A1
(43) Pub. Date: Jun. 27, 2002

(54) COLLAPSIBLE SMALL ANIMAL CARRIER

(76) Inventor: Vanessa L. Roberts, Cape Town (ZA)

Correspondence Address: Kaardal & Associates, PC, Attn: Ivar M. Kaardal, Suite 250, 3500 South First Ave. Circle, Sioux Falls, SD, 57105-5802, US

(21) Appl. No.: 09/747,881

(22) Filed: Dec. 26, 2000

(51) Int. Cl. A01K 31/07; A01K 1/00; A01K 1/03

(52) U.S. Cl. 119/453

(57) ABSTRACT

A collapsible small animal carrier for providing an easy-to-store and easy-to-access pet carrier. The collapsible small animal carrier includes a plurality of panels being interconnected to form a box-like structure; and also includes a plurality of strap-like connectors for interconnecting the panels; and further includes a carrying strap being removably fastened to the box-like structure with strips of hook and loop fasteners; and also includes a latch assembly for securely closing the box-like structure.

### BACKGROUND OF THE INVENTION

1. Field of the Invention

The present invention relates to a portable small animal kennel and more particularly pertains to a new collapsible small animal carrier for providing an easy-to-store and easy-to-access pet carrier.

2. Description of the Prior Art

The use of a portable small animal kennel is known in the prior art. More specifically, a portable small animal kennel heretofore devised and utilized are known to consist basically of familiar, expected and obvious structural configurations, notwithstanding the myriad of designs encompassed by the crowded prior art which have been developed for the fulfillment of countless objectives and requirements.

Known prior art includes U.S. Pat. Nos. 4,256,056; 3,306,258; 4,484,540; 5,570,658; 5,134,974; and U.S. Patent No. Des. 333,709.

While these devices fulfill their respective, particular objectives and requirements, the aforementioned patents do not disclose a new collapsible small animal carrier. The inventive device includes a plurality of panels being interconnected to form a box-like structure; and also includes a plurality of strap-like connectors for interconnecting the panels; and further includes a carrying strap being removably fastened to the box-like structure with strips of hook and loop fasteners; and also includes a latch assembly for securely closing the box-like structure.

In these respects, the collapsible small animal carrier according to the present invention substantially departs from the conventional concepts and designs of the prior art, and in so doing provides an apparatus primarily developed for the purpose of providing an easy-to-store and easy-to-access pet carrier.

### SUMMARY OF THE INVENTION

In view of the foregoing disadvantages inherent in the known types of portable small animal kennel now present in the prior art, the present invention provides a new collapsible small animal carrier construction wherein the same can be utilized for providing an easy-to-store and easy-to-access pet carrier.

The general purpose of the present invention, which will be described subsequently in greater detail, is to provide a new collapsible small animal carrier which has many of the advantages of the portable small animal kennel mentioned heretofore and many novel features that result in a new collapsible small animal carrier which is not anticipated, rendered obvious, suggested, or even implied by any of the prior art portable small animal kennel, either alone or in any combination thereof.

To attain this, the present invention generally comprises a plurality of panels being interconnected to form a box-like structure; and also includes a plurality of strap-like connectors for interconnecting the panels; and further includes a carrying strap being removably fastened to the box-like structure with strips of hook and loop fasteners; and also includes a latch assembly for securely closing the box-like structure.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is therefore an object of the present invention to provide a new collapsible small animal carrier which has many of the advantages of the portable small animal kennel mentioned heretofore and many novel features that result in a new collapsible small animal carrier which is not anticipated, rendered obvious, suggested, or even implied by any of the prior art portable small animal kennel, either alone or in any combination thereof.

It is another object of the present invention to provide a new collapsible small animal carrier which may be easily and efficiently manufactured and marketed.

It is a further object of the present invention to provide a new collapsible small animal carrier which is of a durable and reliable construction.

An even further object of the present invention is to provide a new collapsible small animal carrier which is susceptible of a low cost of manufacture with regard to both materials and labor, and which accordingly is then susceptible of low prices of sale to the consuming public, thereby making such collapsible small animal carrier economically available to the buying public.

Still yet another object of the present invention is to provide a new collapsible small animal carrier which provides in the apparatuses and methods of the prior art some of the advantages thereof, while simultaneously overcoming some of the disadvantages normally associated therewith.

Still another object of the present invention is to provide a new collapsible small animal carrier for providing an easy-to-store and easy-to-access pet carrier.

Yet another object of the present invention is to provide a new collapsible small animal carrier which includes a plurality of panels being interconnected to form a box-like structure; and also includes a plurality of strap-like connectors for interconnecting the panels; and further includes a carrying strap being removably fastened to the box-like structure with strips of hook and loop fasteners; and also includes a latch assembly for securely closing the box-like structure.

Still yet another object of the present invention is to provide a new collapsible small animal carrier that can be easily and quickly put together and taken apart.

Even still another object of the present invention is to provide a new collapsible small animal carrier that can be conveniently stored out of the way when not needed.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of a new collapsible small animal carrier according to the present invention.

FIG. 2 is a side elevational view of the present invention.

FIG. 3 is a top plan view of the present invention being collapsed.

FIG. 4 is a top plan view of the present invention.

FIG. 5 is another perspective view of the present invention.

### DESCRIPTION OF THE PREFERRED EMBODIMENT

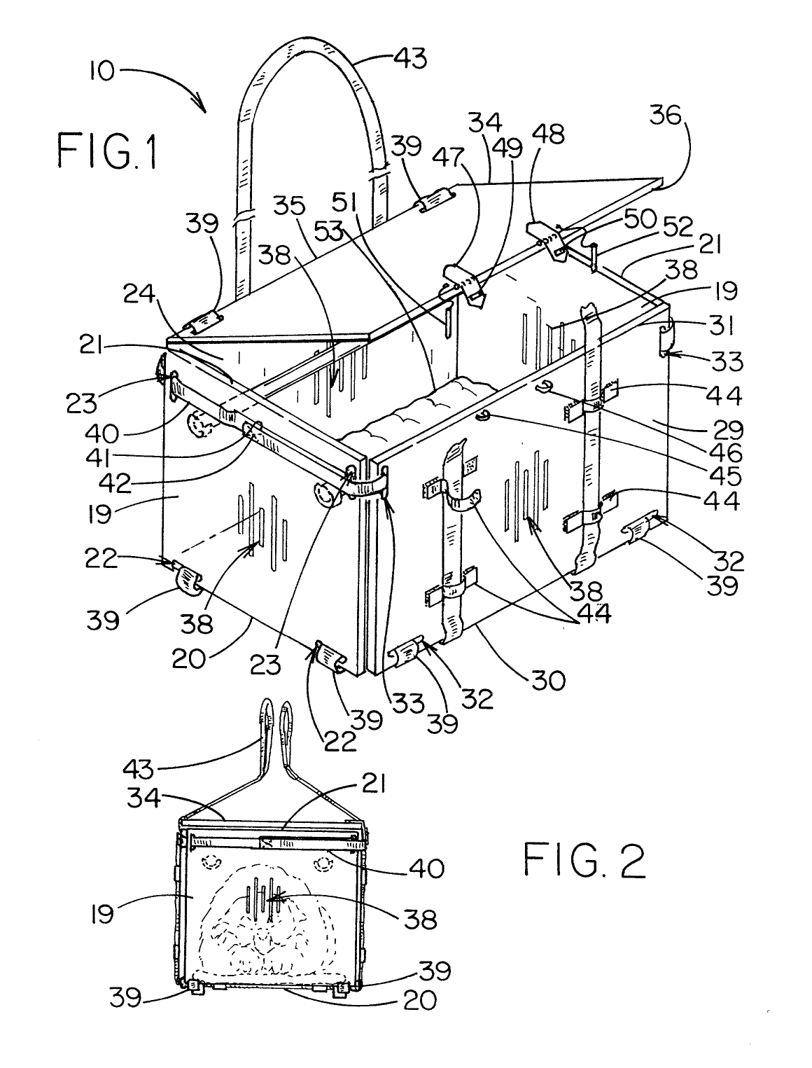

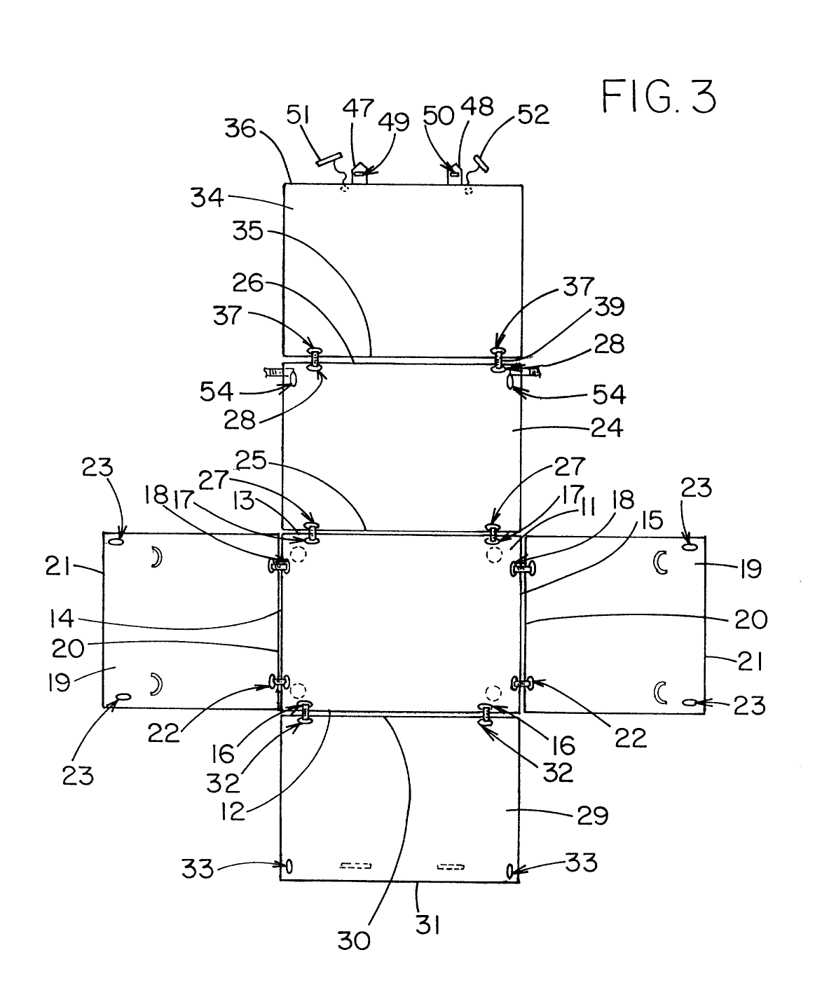

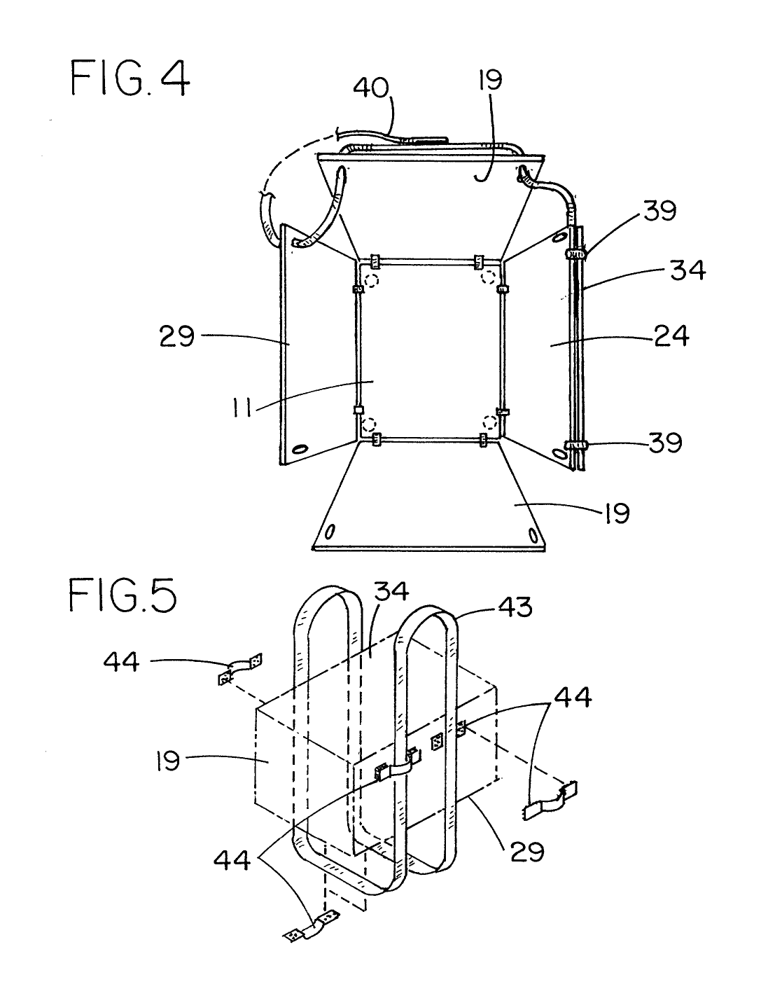

With reference now to the drawings, and in particular to FIGS. 1 through 5 thereof, a new collapsible small animal carrier embodying the principles and concepts of the present invention and generally designated by the reference numeral 10 will be described.

As best illustrated in FIGS. 1 through 5, the collapsible small animal carrier 10 generally comprises a plurality of panels 11, 19, 24, 29, 34 being interconnected to form a box-like structure. The plurality of panels 11, 19, 24, 29, 34 include a base panel 11 having apertures 16, 17, 18 extending therethrough near corners thereof, and also includes side panels 19 having apertures 22, 23 extending therethrough at bottom 20 and top edges 21 thereof, and further includes a back panel 24 also having apertures 27, 28, 54 extending therethrough at bottom, top and side edges 25, 26 thereof, and also includes a front panel 29 also having apertures 32, 33 extending therethrough at bottom and top edges 30, 31 thereof, and further includes a top panel 34 having apertures 37 extending therethrough at a back edge 35 thereof. The apertures 16, 17, 18 of the base panel 11 includes side apertures 18 which are disposed along side edges 14, 15 of the base panel 11, and also include back apertures 18 which are disposed along a back edge 13 of the base panel 11, and further includes front apertures 16 which are disposed along a front edge 12 of the base panel 11. Each of the back apertures 17 of the base panel 11 is aligned with a respective one of the apertures 27 disposed along the bottom edge 25 of the back panel 24. Each of the side apertures 18 of the base panel 11 is aligned with a respective one of the apertures 22 disposed along the bottom edges 20 of the side panels 19, and each of the front apertures 16 of the base panel 11 is aligned with a respective one of the apertures 32 disposed along the bottom edge 30 of the front panel 29. Each of the apertures 28 disposed along the top edge 26 of the back panel 24 is in alignment with a respective one of the apertures 37 disposed along the back edge 35 of the top panel 34. The side, back and front panels 19, 24, 29 have a plurality of slits 38 disposed therethrough to allow an animal to breathe air.

A plurality of strap-like connectors 39, 40 for interconnecting the panels 11, 19, 24, 29, 34 include first strap-like connectors 39 which are looped through the apertures 16-18, 27, 28 of the base panel 11 and the back panel 24 and through the apertures 22, 32 disposed along the bottom edges 20, 30 of the side and front panels 19, 29 and through the apertures 37 disposed along the back edge 35 of the top panel 34. Each of the first strap-like connectors 39 is looped through pairs of the apertures to effectively connect the side, back, and front panels 19, 24, 29 to the base panel 11 and to effectively connect the top panel 34 to the back panel 24. The strap-like connectors 39, 40 further include second strap-like connectors 40 which are looped through the apertures 23, 33, 54 disposed along the top edges 21, 31 of the side and front panels 19, 29 and along the side edges of said back panel 24. At least one of the second strap-like connectors 40 has hook and loop fasteners 41, 42 being securely and conventionally attached at ends thereof and being fastenable to one another to effectively fasten the at least one of the second strap-like connectors 40 together.

A carrying strap 43 is removably fastened to the box-like structure with strips of hook and loop fasteners 44. The strips of hook and loop fasteners 44 are securely and conventionally disposed upon exteriors of the base, front, and back panels 11, 29, 24. The carrying strap 43 is an endless strap having looped ends being extended above the box-like structure.

A latch assembly for securely closing the box-like structure includes eyelets 45, 46 being securely and conventionally attached to an exterior of and along the top edge 31 of the front panel 29, and also includes fastening straps 47, 48 being securely and conventionally attached to an exterior of and along a front edge 36 of the top panel 34 and having holes 49, 50 disposed through end portions therethrough and being adapted to receive the eyelets 45, 46 for securely fastening the top panel 34 upon the box-like structure with bolt-like members 51, 52. A padded member 53 is removably disposed upon the base panel 11 for the comfort of the small animal.

In use, the user interconnects the panels 11, 19, 24, 29, 34 to form the box-like structure and fastens the carrying strap 43 to the box-like structure using the strips of hook and loop fasteners 44 and places the small animal in the box-like structure and secures the top panel 34 upon the box-like structure using the fastening straps 47, 48, the eyelets 45, 46, and the bolt-like members 51, 52.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A collapsible small animal carrier comprising:
a plurality of panels being interconnected to form a box-like structure;
a plurality of strap-like connectors for interconnecting said panels;
a carrying strap being removably fastened to said box-like structure with strips of hook and loop fasteners; and
a latch assembly for securely closing said box-like structure.

2. A collapsible small animal carrier as described in claim 1, wherein said plurality of panels include a base panel having apertures extending therethrough near corners thereof, and also include side panels having apertures extending therethrough at bottom and top edges thereof, and further include a back panel also having apertures extending therethrough at bottom and top edges thereof, and also include a front panel also having apertures extending therethrough at bottom and top edges thereof, and further include a top panel having apertures extending therethrough at a back edge thereof.

3. A collapsible small animal carrier as described in claim 2, wherein said apertures of said base panel include side apertures which are disposed along side edges of said base panel, and also include back apertures which are disposed along a back edge of said base panel, and further include front apertures which are disposed along a front edge of said base panel.

4. A collapsible small animal carrier as described in claim 3, wherein each of said back apertures of said base panel is aligned with a respective one of said apertures disposed along said bottom edge of said back panel, and each of said side apertures of said base panel is aligned with a respective one of said apertures disposed along said bottom edges of said side panels, and each of said front apertures of said front panel is aligned with a respective one of said apertures disposed along said bottom edge of said front panel, and each of said apertures disposed along said top edge of said back panel is in alignment with a respective one of said apertures disposed along said back edge of said top panel.

5. A collapsible small animal carrier as described in claim 4, wherein said strap-like connectors include first strap-like connectors which are looped through said apertures of said bottom panel and said back panel and through said apertures disposed along said bottom edges of said side and front panels and through said apertures disposed along said back edge of said top panel, each of said first strap-like connectors being looped through pairs of said apertures to effectively connect said side, back, and front panels to said base panel and to effectively connect said top panel to said back panel.

6. A collapsible small animal carrier as described in claim 5, wherein said strap-like connectors further include second strap-like connectors which are looped through said apertures disposed along said top edges of said side and front panels, at least one of said second strap-like connectors having hook and loop fasteners being securely attached at ends thereof and being fastenable to one another to effectively fasten said at least one of said second strap-like connectors together.

7. A collapsible small animal carrier as described in claim 6, wherein said side, back and front panels have a plurality of slits disposed therethrough to allow an animal to breathe air.

8. A collapsible small animal carrier as described in claim 7, wherein said strips of hook and loop fasteners are securely disposed upon exteriors of said base, front, and back panels.

9. A collapsible small animal carrier as described in claim 8, wherein said carrying strap is an endless strap having looped ends being extended above said box-like structure.

10. A collapsible small animal carrier as described in claim 9, wherein said latch assembly includes eyelets being securely attached to an exterior of and along said top edge of said front panel, and also includes fastening straps being securely attached to an exterior of and along a front edge of said top panel and having holes disposed through end portions therethrough and being adapted to receive said eyelets for securely fastening said top panel upon said box-like structure.

11. A collapsible small animal carrier as described in claim 10 further includes a padded member being removably disposed upon said base panel for the comfort of the small animal.

12. A collapsible small animal carrier comprising:
a plurality of panels being interconnected to form a box-like structure, said plurality of panels including a base panel having apertures extending therethrough near corners thereof, and also including side panels having apertures extending therethrough at bottom and top edges thereof, and further including a back panel also having apertures extending therethrough at bottom and top edges thereof, and also including a front panel also having apertures extending therethrough at bottom and top edges thereof, and further including a top panel having apertures extending therethrough at a back edge thereof, said apertures of said base panel including side apertures which are disposed along side edges of said base panel, and also including back apertures which are disposed along a back edge of said base panel, and further including front apertures which are disposed along a front edge of said base panel, each of said back apertures of said base panel being aligned with a respective one of said apertures disposed along said bottom edge of said back panel, and each of said side apertures of said base panel being aligned with a respective one of said apertures disposed along said bottom edges of said side panels, and each of said front apertures of said front panel being aligned with a respective one of said apertures disposed along said bottom edge of said front panel, and each of said apertures disposed along said top edge of said back panel being in alignment with a respective one of said apertures disposed along said back edge of said top panel, said side, back and front panels having a plurality of slits disposed therethrough to allow an animal to breathe air;
a plurality of strap-like connectors for interconnecting said panels, said strap-like connectors including first strap-like connectors which are looped through said apertures of said bottom panel and said back panel and through said apertures disposed along said bottom edges of said side and front panels and through said apertures disposed along said back edge of said top panel, each of said first strap-like connectors being looped through pairs of said apertures to effectively connect said side, back, and front panels to said base panel and to effectively connect said top panel to said back panel, said strap-like connectors further including second strap-like connectors which are looped through said apertures disposed along said top edges of said side and front panels, at least one of said second strap-like connectors having hook and loop fasteners being securely attached at ends thereof and being fastenable to one another to effectively fasten said at least one of said second strap-like connectors together;
a carrying strap being removably fastened to said box-like structure with strips of hook and loop fasteners, said strips of hook and loop fasteners being securely disposed upon exteriors of said base, front, and back panels, said carrying strap being an endless strap having looped ends being extended above said box-like structure;
a latch assembly for securely closing said box-like structure, said latch assembly including eyelets being securely attached to an exterior of and along said top edge of said front panel, and also including fastening straps being securely attached to an exterior of and along a front edge of said top panel and having holes disposed through end portions therethrough and being adapted to receive said eyelets for securely fastening said top panel upon said box-like structure; and
a padded member being removably disposed upon said base panel for the comfort of the small animal.
